(19) United States
(12) Patent Application Publication
(10) Pub. No.: US 2023/0154348 A1
(43) Pub. Date: May 18, 2023

(54) SYSTEM FOR FACILITATING ONLINE LEARNING TO TEACHERS AND STUDENTS VIA VIDEO GROUP CALL ENVIRONMENT

(71) Applicant: Ogoul Technology Co., W.L.L., Doha (QA)

(72) Inventors: SALAH M. WERFELLI, MORGAN HILL, CA (US); SAM L. APPLETON, MORGAN HILL, CA (US); TANWIR ZAFAR SYEDMOHAMMAD, TRACY, CA (US)

(21) Appl. No.: 17/525,192

(22) Filed: Nov. 12, 2021

(51) Int. Cl. G09B 5/14; G09B 5/06; G06F 16/955; H04L 12/18

(52) U.S. Cl. CPC G09B 5/14; G09B 5/067; G06F 16/9566; H04L 12/1831

(57) ABSTRACT

The present invention discloses a system for facilitating online learning. The present invention particularly relates to a system for facilitating online learning to teachers and students via video group call environment. The present invention comprises three portals i.e. admin portal, teachers portal and students portal.

### CROSS REFERENCE OF RELATED APPLICATION(S)

This application claims the benefit of U.S. Provisional Application No. 63/11,3038, filed Nov. 12, 2020; each of the foregoing applications is incorporated by reference herein in its entirety.

### FIELD OF THE INVENTION

The present invention relates to a system for facilitating online learning. The present invention particularly relates to a system for facilitating online learning to teachers and students via video group call environment. The present invention comprises three portals i.e. admin portal, teachers portal and students portal.

### BACKGROUND OF THE INVENTION

Computer-based teaching and learning has become increasingly popular today. Computer-aided learning is at its simplest, in that the student learns independently using a personal computer (PC) based learning software. In a classroom environment, a teacher typically teaches a group of students, each with workstations connected to the teacher's workstation. Computer-aided teaching brings new challenges to teachers. They need to get students to launch application programs and open documents with application software. All of this requires a great deal of guidance, support and supervision to ensure that all students are using the program properly. A teacher may spend time running around the classroom opening and restarting computers, using applications, and trying to figure out what the students are actually doing. This takes a lot of valuable teaching time. As teachers' own IT skills vary, it is not self-evident that all teachers can provide students with all the information they need at any given time.

Today, publishers and other content providers produce software products that are rich in study material (eg CD-ROI \/publications). In addition, there is a huge amount of learning material available on the Internet. Publishers also have websites on the Internet, referred to herein as learning portals, which students can access through the Internet. Such material would also be valuable during online classes for students in a networked computer classroom (the system is connected to external computer networks and/or the Internet), but it is very difficult to make logical and well-structured guided learning based on the learning material available on the Internet and a group of 30 students, according to the lesson plan, without creating chaos in the classroom. This is especially true when students should use Internet web pages and websites as online learning material during the lesson.

The invention seeks to provide new technical tools for assisting online computer-assisted learning activities.

### SUMMARY OF THE INVENTION

Accordingly, in one aspect of the present invention a system for facilitating online learning to teachers and students via video group call environment comprising:
a) an admin portal;
b) a teacher portal;
c) a student portal; and
d) a network connecting said teacher portal and once student portal;
   wherein, said teacher portal includes the user interface that allows the teacher to control the operation of said at least one student portal through said network, said at least one student portal having a web browser whose browsing functions can be remotely controlled by said teacher application through said network.

In another aspect of the present invention the aforementioned said system having control functions which enable the teacher to control the operation of said at least one student workstation through said network, controlling a web browser function on said at least one student portal via said network according to the control functions selected by the teacher.

In another aspect of the present invention the aforementioned said system further consists a computer readable medium containing computer software, wherein executing said software on a computer causes the computer to perform a system.

In another aspect of the present invention the aforementioned said system excuting the aforementioned computer software on a computer causes the computer to perform a method.

In another aspect of the present invention the aforementioned said system a web server is provided to access to a plurality of web pages in the form of multi-faceted learning material, characterized in that said web server includes at least one web page having a hyperlink to a configuration file which, when down-loaded by a user on the computer, in response to activating said hyperlink, configures the user interface of the learning program running on said computer to support a predefined lesson plan that includes predefined web page links.

In another aspect of the present invention the aforementioned said system the aforementioned system is performed in a teacher's computer workstation that controls learning activities in a networked computer-based learning system, a teacher's workstation of said networked computer-based learning system, at least one student workstation.

In another aspect of the present invention the aforementioned said system the aforesaid system having control functions which enable the teacher to control the operation of said at least one student workstation through said network, controlling a web browser function on said at least one student portal via said network according to the control functions selected by the teacher.

### DETAILED DESCRIPTION OF THE INVENTION

The present invention may be understood more readily by reference to the following detailed description. It is to be understood that this invention is not limited to the specific devices, methods, conditions or parameters described and/or shown herein and that the terminology used herein is for the example only and is not intended to be limiting of the claimed invention. Also, as used in the specification including the appended claims, the singular forms ‘a’, can', and ‘the’ include the plural, and references to a particular numerical value includes at least that particular value unless the content clearly directs otherwise. Ranges may be expressed herein as from ‘about’ or ‘approximately’ another particular value when such a range is expressed another embodiment. Also, it will be understood that unless otherwise indicated, dimensions and material characteristics stated herein are by way of example rather than limitation, and are for better understanding of sample embodiment of suitable utility, and variations outside of the stated values may also be within the scope of the invention depending upon the particular application.

Embodiments will now be described in detail. To avoid unnecessarily obscuring the present disclosure, well-known features may not be described substantially or the same elements may not be redundantly described. This is for ease of understanding.

The following description are provided to enable those skilled in the art to fully understand the present disclosure and are in no way intended to limit the scope of the present disclosure as set forth.

In one embodiment of the present invention, a system for facilitating online learning is disclosed.

One aspect of the invention relates to a computer-aided online learning activity management system, said system consisting of admin portal, a teacher portal, at least one student portal, and a network connecting said teacher portal and said at least one student portal, wherein said teacher portal includes The user interface allows the teacher to control the operation of said at least one student portal through said network, said at least one student portal having a web browser whose browsing functions can be remotely controlled by said teacher application through said network.

Another aspect of the invention relates to a method for managing online computer-aided learning learning activities, said networked learning system comprising a teacher's portal, at least one student portal and a network linking said teacher's portal and said at least one student portal, said method comprising: having control functions which enable the teacher to control the operation of said at least one student workstation through said network, controlling a web browser function on said at least one student portal via said network according to the control functions selected by the teacher.

A further aspect of the invention relates to a computer readable medium containing computer software, wherein executing said software on a computer causes the computer to perform a method. Another aspect of the invention relates to computer software, wherein executing said software on a computer causes the computer to perform a method.

Another aspect of the invention is a web server providing access to a plurality of web pages in the form of multi-faceted learning material, characterized in that said web server includes at least one web page having a hyperlink to a configuration file which, when downloaded by a user on the computer, in response to activating said hyperlink, configures the user interface of the learning program running on said computer to support a predefined lesson plan that includes predefined web page links.

Another aspect of the invention is a method performed in a teacher's computer workstation that controls learning activities in a networked computer-based learning system, a teacher's workstation of said networked computer-based learning system, at least one student workstation, and said teacher's workstation and at least one downloading a configuration file from a web server providing access to a plurality of web page-rich learning materials, said configuration information defining a predetermined lesson plan including predefined web page links, configuring a user application running on said teacher's workstation to configure a user interface; a predefined hour plan and display a predefined web-page links.

A further aspect of the invention relates to a computer readable medium containing computer software, wherein executing said software on a computer causes the computer to perform a method. Another aspect of the invention relates to computer software, wherein executing said software on a computer causes the computer to perform a method

In one embodiment of the invention a detailed outline of the system is presented below for the mere understanding of the invention. It must be pertinent to note that the below explanation is for explanation and not to limit the scope of the invention.

### Admin Portal:

### Dashboard:

Dashboard page shows the list of classes of current day.
Admin can see the start/end time and status of each class.

Status can be

In Progress
Not Started
End Call
Class Cancelled

Courses:
This page shows the list of courses and classes.
Admin can add New Class under any Course.
There is a button at top right corner called “Add Class in Course”. By clicking this button will open a form in a popup window where admin can add multiple classes and their start and end date at once.
Admin can add/Edit Schedule (Class Day, Start time and end time) against each class.
Admin can assign a teacher to a class.
Admin can enroll multiple students in a class by clicking the option “Students” in Students column.
Admin can Edit or delete a class and its schedules.
Admin can Change a teacher against any class by clicking the “Change” link under the teacher's name.

Teachers:
This page shows the list of teachers.
Admin can add a new teacher by clicking the button “Add New Record” at top right corner.
Admin can edit or delete any teacher from this page.

Students:
This page shows the list of all the students enrolled in this school.
Admin can sort the students by Name or Email.
Admin can add a new student by clicking the button “Add New Record”.
Admin can add multiple students at bulk by using a CSV file. He has to load the students data in a csv file and upload the file here.
Admin can download a sample csv file to see the format.
Admin can edit or delete any student.

Scheduled Classes:
This page shows the list of all classes.
Each record shows the teacher's name and the number of students got enrolled in this class.
Admin can delete any class from this page.

Assignments:
This page shows the list of all the assignments added by all the teachers in this school.
Admin can filter the assignment list by Teacher Name.
   Submission
      Admin can see how much submission has been done against each assignment.
   Assignment Detail
      By clicking any Assignment title will take the admin to its detail page where can see complete description, files uploaded by teacher and total number of submissions.

Logout:
This option will logout the admin and redirect him to the login page

Forget Password:
By clicking the forget password will open a form where user has to enter his/her email address and press submit button. An email will be sent to the user along with the confirmation link.

Students Portal:

User: student@email.com

Pass: ****

Dashboard:
Dashboard page shows the list of classes of current day.
Student can see the start/end time and Action of each class.
   Action
This column shows the JOIN CALL button if the call is already connected.
   Join Call
By clicking this button, student can join an ongoing call.
   Accept Call

When teacher send a call request to students, student get a popup window with two buttons Accept and Reject Call.

By clicking Accept button, student will join an ongoing call.
Reject Call

By clicking Reject button, popup will be removed and a new button called “Join Call” will be displayed under the “Action” column next to that specific class. So student can click “Join Call” button to join that ongoing call.

My Courses:
Enrollment

Through My Courses section, student can get enrolled in any course and a specific class under that course.
My Classes

This section shows the list of classed in which student has already got enrolled. Student can delete any record to get disenrollment from that class.

My Classes:
This page shows the list of all the classes in which student had already got enrolled.
This page is divided into sections; each section shows a specific course and its classes.
Student can see the summary of all his classes/start time/end time and teacher's name.
   Enroll in a class

There is a button at top right corner called “Enroll in a class”. By clicking this button will take the student to the Enrollment page where student can select any course and class to get enrollment.

History:
This page shows the list of lectures history.
Whenever a lecture is started by teacher, its video recording and audio/video chat is stored into history page.
Student can download history of any lecture any time.
This page shows the lecture day/time/and a link called “Download”.
   Download

By clicking Download link will take the student to the next page where student can download the following material against a lecture
Chat History

Student can read/copy the chat history which was saved during the lecture.
Files History
   Student can view or download the files shared by teacher or other students during the lectures.
   Files can be in a docs, xls, pdf, power point sliders or audio video format.
Download Video

Student can download the video recording/movie of lecture. Our system stores the lecture in video format as well.

Assignments:
This page shows the list of all the assignments uploaded by teachers.
Student can see the course name and due date along with the assignment title.
   Assignment Detail

Student can click the assignment title to see the complete detail of that specific assignment and files uploaded by teacher along with that assignment.
My Submission
Student can submit his assignment from the My Submission section.
Student can upload multiple files by clicking PLUS (+) icon.

Logout:
This option will logout the student and redirect him to the login page.

Teachers Portal:

User: teacher@email.com

Pass: ****

Dashboard:
Dashboard page shows the list of classes of current day.
Teacher can see the start/end time and Action of each class.
Action
   This column shows the status of that specific class. Status can be:
      In Progress
      Not Started
      Class Ended
      Class Cancelled
      Start Class
      Join Class
Cancel a Class

Teacher can cancel a class by clicking “Cancel” button which will be appeared just before the 15 minutes of class start time.
Start Lecture
   Teacher can start a lecture by clicking on the “Start Lecture” button which will be shown just before 15 minutes of class start time.
   As the teacher click on “Start Lecture” button, a video call session is started in a new window and a call request is sent to all those students who have been got enrolled in that specific class.
Join a Class

If a teacher has started a class and mistakenly, he restarted his computer then he can join the same class by clicking “Join Call” button appeared next to that ongoing class.
Class Room Environment

As the teacher starts a class, a video call request is sent to students and call screen is opened at teacher's end where teacher can see and listen all the students.

There are different kind of options and controls at teacher's end, as described below.
Lecture Mode

This is default mode when a call is connected. In lecture mode, teacher can see all the students but students can see only teacher's video not any other student.
Conference Mode

In Conference mode, students and teachers can see and listen to one another.
Mute/Unmute Teacher

Teacher can mute/unmute himself/herself so students can not listen him/her.
Mute/Unmute Students

Teacher has the option to mute any student. He just has to take the mouse over the player of any student where he can see the mute option for that specific student.
Zoom In Video

Teacher has the option to see the large view of any student. He just has to take the mouse over the player of any student where he can see the zoom option for that specific student.
Share Screen

Both (teacher and students) has the option to share their screen. There is an icon at the bottom of the screen just near the END CALL button, when teacher click that icon, system will ask him/her to share his whole browser, specific tab or whole desktop. So as he/she select an option, his video player will be turned into screen which can be seen by other users/students who had joined the call.
White Board
   Teacher has the option to present into white board. There is an icon at the bottom of the call screen to open white board.
   Teacher can share his screen and open the white so students can see what teacher is writing/drawing on the white board.
   White board itself has many options in it.
Chalk

By default, chalk is selected in the white board, so that teacher may write anything on the white board and students can see it.
Rectangle

There is an option in the white board to draw a rectangle, so teacher just has to select rectangle option is he/she wants to draw a rectangle.
Line There is an option in the white board to draw a line. So teacher can select a line if needed.
Line/font thickness

There are different thickness options available in the whiteboard so teacher can select any option to draw a line or write something.
Eraser

Whiteboard also has Eraser button at the bottom right corner, so teacher can select the eraser to erase anything.
Color Options

Whiteboard has different color options so teacher can select to write in any color.
Text Chat Panel

Both (teacher and students) can see a chat panel on the call screen so they can send or receive text messages instantly.
File Sharing Option

Both (teacher and students) has file sharing option in the chat panel so they can share any kind of file (docx, xlsx, power point, pdf, audio, video).
Video Recording of Lecture

When teacher starts a lecture, an automatic video recording starts till the end of lecture. When teacher ends a call, that video recording file is automatically downloaded at students desktop and a copy of that file will be uploaded to the server which can be downloaded by the students anytime from Lecture History section.

My Schedule:
My schedule page shows the list of all the courses/classes of a specific logged in teacher.
Teacher can see the start/end time and Action of each class.
Action

This column shows the status of that specific class. Status can be
In Progress
Not Started
Class Ended
Class Cancelled

My Assignments:
This page shows the list of all the assignments uploaded by teacher.
Teacher can see the course name and due date and total number of submissions along with the assignment title.
Create New Assignment
   There is a button at top right corner called “Create New”. By clicking this button will open a form to add a new assignment.
   Teacher has to choose a course and enter assignment title, due date, description and upload multiple files if needed.
   These assignment will be shown to the students belongs to that specific course.
Edit Assignment

Teacher can edit an assignment by clicking the Edit button next to that specific record. By clicking edit button will open a form where teacher can edit the detail of that assignment.
Delete Assignment

Teacher can delete an assignment by clicking the button “Delete” next to each record.
Assignment Details

Teacher can see full detail of assignment by clicking the title of the assignment.
Submissions
   Teacher can see the total number of submissions and list of students who has submitted the assignment.
   Teacher can also download the files submitted by student.
Return an Assignment
   Teacher can return an assignment by clicking the “Return” button next to each assignment.
   Teacher can also post public and private comments against each submission.
   Teacher can also upload the files while posting comments. Suppose teacher has checked the assignment and highlighted some issue and want to send back to student so he/she can upload that file in the comments section.
   Public comments will be shown to the student while private comments are just for the teacher as specific notes.

Logout:
This option will logout the teacher and redirect him/her to the login page

In the illustrated embodiment of the invention, the data network is a LAN, e.g. an IP (Internet Protocol) network. However, whether the data network is a local, nationwide, or global network such as the Internet is irrelevant to the features and functions described below.

Computers can be any standard computer that is powerful enough for the operating system and applications and tasks for which they are commonly used. For example, your computer may have an Intel Pentium 166 MHz or higher processor, 32 MB of RAM, Microsoft Windows 95, 98, or NT 4.0, a 10 MB hard drive, and support for TCP/IP network protocol.

In a preferred embodiment of the invention, the control operation of this invention is performed by software installed on standard computers. The software is preferably divided into three separate software components: teacher, chant and server (tutor, client, crossroad). The component you choose to install depends on how you use that computer. The teacher uses the teacher component, which is the system's main interface. The teacher component allows the teacher to control the computers in the classroom, their applications, and their use, The Teacher interface (UI) shows the workstations in the “Classroom view” in the classroom graphically as they are located inside the classroom physically. The teacher can form groups of workstations and assign different tasks to different groups at any time. The teacher component, together with the client component and the server component, can provide a variety of functions: software control: controlling undivided or shared documents: locking desktops; allowing only selected applications to be used on locked workstations; sending messages to an individual workstation or workstation group: closing workstations; restarting workstations; locking operating system (Windows) workstations; computer monitoring and remote access; sending an image of any computer screen website.

The client software components are located on the workstations and used by the students. When the client components are installed on the workstations and and the system is running, the client components respond to commands sent by the teacher component. When the client component receives the command from the teacher component, it interprets it and performs the requested task. The chant component communicates with the paper component when system starts up and starts listening to commands. Client component is running in the background and is completely invisible to the user.

Once the portfolio content has been added to the interface, the lesson can be continued, as with any locally created portfolio.

As explained above, the invention allows the teacher to vary the level of guidance required by the lesson, Some lessons may require very tight guidance, while others require looser control. In one embodiment of the invention, the teacher has the ability to send students all shortcuts in the teacher's portfolio and allow them to choose which web links they use and in which order. Providing resources in this way allows the teacher to evaluate the student's engagement and thinking process. An hourly plan view can consist of three fields: goals, activities, and outputs. Goals are the goal of the lesson, the results that should be achieved in a given lesson. Activities are lesson-lesson tasks. Output is the expected end result of the lesson. One possible direction for further development of this feature is also the sending off learning objectives, activities and output to students in the form of a text file. This would better inform students why they have to perform the task, what they are required to do and what they should learn during the process.

When the teacher in the above examples clicks on the hyperlink on the portal, all web links are automatically added to the teacher navigation interface. In another embodiment of the invention, these pages are automatically stored in the proxy server or, in the absence of a server, in a shared area of the teacher's workstation hard drive. This wok..ild have the advantage that when students reopen or access these pages, cached copies are used instead of opening the pages over the Internet. Get to your site faster and more reliable. When the teacher closes the portfolio or shuts down the machine, the system can delete the cached pages. This eliminates the possibility that slow Internet connections will affect the lesson.

These solutions require the portal provider to create these portfolio files and add them as hyperlinks to the content of their portal. For this purpose, portal providers may have a teacher application installed on one or more workstations in their office. The web links would then be manually added (in the same way as for local use) and the resulting portfolio stored as a portfolio file for down-loading to the portal in the appropriate location.

When a school obtains access to such a learning portal, it will receive a printed instruction manual for teachers. This helps the teacher to make the most of the learning portal and gives them practical guidance. However, another embodiment of the invention provides some form of lesson plan that can be used to add learning objectives, teaching activities, and learning outcomes to the portfolio when creating a portal hyperlink. This information may be used in addition to or in addition to the printed instructions.

Although a portal provider has created several portfolio links for teachers, there are always teachers who want to create their own portfolio. In one embodiment of the invention, the teacher can design his or her own web portfolio and the embedded browser of the teacher's application takes care of access to the portal. This would allow the user to select generic portfolios and easily add links to other related web pages that enhance the portal's learning goals.

The integration of portfolio links in the learning portal brings many benefits to teachers. It provides an advanced mechanism from which a teacher can bring portal learning resources into the classroom environment. The teacher has quick and easy access to the content of the portal and does not have to scroll through the portal before each lesson, as he can simply download his stored portfolios. Teachers can customize the generic content of the portal to match the teaching methods they want and then share it with other teachers. It allows teaching to take into account the different skills and levels of pupils. The teacher's applications can be used to send different students different links according to their skills.

The description of the preferred embodiments is made only to illustrate the invention. The invention is not intended to be limited to these examples, but modifications and modifications may be made without departing from the spirit and scope of the appended claims.

What is claimed is:

1. A system for facilitating online learning to teachers and students via video group call environment comprising:
a) an admin portal;
b) a teacher portal:
c) a student portal; and
d) a network connecting said teacher portal and once student portal;
wherein, said teacher portal includes the user interface that allows the teacher to control the operation of said at least one student portal through said network, said at least one student portal having a web browser whose browsing functions can be remotely controlled by said teacher application through said network.

2. The system for facilitating online learning as claimed in claim 1 wherein, said system having control functions which enable the teacher to control the operation of said at least one student workstation through said network, controlling a web browser function on said at least one student portal via said network according to the control functions selected by the teacher.

3. The system for facilitating online learning as claimed in claim 1 wherein, said system further consists a computer readable medium containing computer software, wherein executing said software on a computer causes the computer to perform a system.

4. The system for facilitating online learning as claimed in claim 1 wherein, excuting the aforementioned computer software on a computer causes the computer to perform a method.

5. The system for facilitating online learning as claimed in claim 1 wherein, a web server is provided to access to a plurality of web pages in the form of multi-faceted learning material, characterized in that said web server includes at least one web page having a hyperlink to a configuration file which, when down-loaded by a user on the computer, in response to activating said hyperlink, configures the user interface of the learning program running on said computer to support a predefined lesson plan that includes predefined web page links.

6. The system for facilitating online learning as claimed in claim 1 wherein, the aforementioned system is performed in a teacher's computer workstation that controls learning activities in a networked computer-based learning system, a teacher's workstation of said networked computer-based learning system, at least one student workstation.

7. The system for facilitating online learning as claimed in claim 1 wherein, the aforesaid system having control functions which enable the teacher to control the operation of said at least one student workstation through said network, controlling a web browser function on said at least one student portal via said network according to the control functions selected by the teacher.
